(19) United States
(12) Patent Application Publication
(10) Pub. No.: US 2025/0086533 A1
(43) Pub. Date: Mar. 13, 2025

(54) DECENTRALIZED PRIVATE CHARGING NETWORK FOR VEHICLES

(71) Applicant: GM Cruise Holdings LLC, San Francisco, CA (US)

(72) Inventor: Mohamed Mostafa ElShenawy, Burlingame, CA (US)

(21) Appl. No.: 18/465,754

(22) Filed: Sep. 12, 2023

(51) Int. Cl. G06Q 10/0631

(52) U.S. Cl. CPC G06Q 10/06311

(57) ABSTRACT

Systems and techniques are provided for a decentralized private service network for autonomous vehicles (AVs). An example method can include receiving a request to register a user premises as a private service station that AVs can use to receive maintenance, the request specifying an availability of the user premises for use to receive maintenance; in response to the request, adding the user premises to a network of service stations including a plurality of user premises registered as private service stations for use by the AVs to receive maintenance and AV service facilities operated by a commercial business/businesses; determining a distance between an AV and the user premises; and determining whether to schedule a battery of the AV to be charged at the user premises based on a charge level of the battery, the specified availability of the user premises, and the distance between the AV and the user premises.

### BACKGROUND

### 1. Technical Field

The present disclosure generally relates to implementing and managing service station networks for electric vehicles and, more specifically, a decentralized private service network for autonomous vehicles.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle navigation and routing operations, according to some examples of the present disclosure;

FIG. 2 is a diagram illustrating an example system environment for a decentralized network of private service stations for vehicles, according to some examples of the present disclosure;

FIG. 3 is a diagram illustrating an example implementation of a vehicle management system, according to some examples of the present disclosure;

FIG. 4 is a diagram illustrating an example scene where autonomous vehicles can be dispatched to user premises to receive maintenance services, according to some examples of the present disclosure;

FIG. 5 is a diagram illustrating an example of a neural network that can be used to implement aspects of a vehicle management system, according to some examples of the present disclosure;

FIG. 6 is a flowchart illustrating an example process for implementing a decentralized network of private service stations along with a network of vehicle service facilities, according to some examples of the present disclosure; and

FIG. 7 is a diagram illustrating an example system architecture for implementing certain aspects described herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, a time-of-flight (TOF) sensor, an inertial measurement unit (IMU), and/or an acoustic sensor (e.g., sound navigation and ranging (SONAR), microphone, etc.), global navigation satellite system (GNSS) and/or global positioning system (GPS) receiver, amongst others. The AVs can use the various sensors to collect data and measurements that the AVs can use for AV operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc. The sensors can provide the data and measurements to an internal computing system of the autonomous vehicle, which can use the data and measurements to control a mechanical system of the autonomous vehicle, such as a vehicle propulsion system, a braking system, and/or a steering system, for example.

AVs are rapidly advancing in technology and deployment, and are increasingly used for a variety of services such as, for example, ridesharing or ride-hailing services and delivery services, among others. For example, AVs can be used to deliver product orders to customers without the need of a human driver. As another example, AVs can be used for ridesharing and/or ride-hailing services to transport passengers from one location to another. In contrast to conventional transportation services where a human driver picks up passengers and drives them to their destination, AVs can drive themselves, eliminating the need for a human driver. For example, upon receiving a ride request from a user/user device (e.g., a ride requestor), an AV management system may match and dispatch an AV in one or more fleets of AVs to the user. In addition to matching and dispatching, the AV management system can manage operations and maintenance of the AVs in the fleet. In order to optimize the efficiency of the fleet while taking into account maintenance service needs (e.g., battery charging needs, sensor calibration needs, routine maintenance needs, etc.) of AVs in a fleet, the AV management system can dispatch AVs to their respective tasks and routes, and manage timely and proper maintenance of the AVs.

AVs in a fleet generally have to make frequent trips to AV service stations to recharge their batteries. Given the battery and power consumption needs of AVs, it can be very difficult to schedule AV tasks and routes while managing their power consumption needs and timely access to AV service stations to recharge their batteries. Moreover, the number of AV service stations available in an area is often limited, particularly as more AVs are deployed in the area thus driving up the demand from AVs for charging opportunities at the AV service stations. The limited number of AV service stations in an area and the demand of AVs for charging opportunities at the AV service stations can increase the difficulty of scheduling AV tasks and routes while managing their power consumption needs and timely access to AV service stations for recharging.

Systems, apparatuses, processes (also referred to as methods), and computer-readable media (collectively referred to as “systems and techniques”) are described herein for a decentralized private service network for autonomous vehicles. In some examples, the decentralized private service network can include a network of private premises (e.g., user homes, garages, etc.) registered by users associated with the private premises as private service stations available to AVs in a fleet. An AV management system can register the private premises as private service stations that AVs in a fleet can use to obtain various types of maintenance services needed by the AVs. The AV management system can schedule and/or dispatch any AV in a fleet to use any of the private premises for maintenance service needs of the AV, such as battery charging and vehicle maintenance, and thereby increase the amount of service stations available to AVs in an area. For example, when an AV needs to recharge its battery, the AV management system can determine whether to dispatch the AV to a private premises in the decentralized private service network to recharge its battery, dispatch the AV to a public service station, or wait to dispatch the AV to a private premises or a public service station at a later time.

To illustrate, if a user associated with private premises that includes battery charging infrastructure wants to volunteer the private premises as a private charging station where AVs in a fleet can go to recharge their batteries, the user can register the private premises with an AV management system that manages a decentralized private service network. When registering, the user can specify days and/or times when the battery charging infrastructure at the private premises would be available for use by AVs in the fleet and the user (or any other user in the private premises) would be available to connect an AV to the battery charging infrastructure to recharge the battery of the AV. The AV management system can register the private premise, including the location of the private premises and the schedule provided by the user associated with the private premises, to include the private premises in the decentralized private service network. The AV management system can consider the private premises as an option for AVs in the area to recharge their batteries during the days and/or times specified by the user when registering the private premises.

If the AV management system intends to dispatch an AV to the private premises for charging, the AV management system can notify the user and request confirmation that the user and the battery charging infrastructure will indeed be available for the AV at a specified time (or time range) when the AV is estimated to arrive at the private premises. If the user confirms such availability, the AV management system can dispatch the AV to the private premises. Upon arrival of the AV at the private premises, the user can connect the AV to the battery charging infrastructure to charge the battery of the AV. If the user does not provide confirmation to the AV management system (or does not provide confirmation within a threshold amount of time), the AV management system can determine whether to dispatch the AV to another private premises in the area, dispatch the AV to a public service station in the area, or wait to dispatch the AV at a later time.

To determine whether to dispatch an AV to a particular service station in an area (e.g., a private service station in a registered private premises or a public service station), the AV can take into account a number of risk and reward factors such as, for example and without limitation, the battery charge level of an AV, the distance to a private service station from a location of the AV, the distance to a public service station from the location of the AV, the number of additional private service stations within a threshold proximity to a candidate private service station that are available as backup options in case the AV is dispatched to the candidate private service station and does not receive charging assistance by a user at the candidate private service station, the amount of AV services in the area of the AV (and associated fees) that the AV would forego if the AV is dispatched to the private service station or a public service station at a particular time, the amount of AV services in the area of the AV (and associated fees) that the AV would forego if dispatching the AV to the private service station or a public service station is delayed until a future time and the risk that a battery charge level of the AV may fall below a certain amount if charging of the AV's battery is delayed until the future time, an amount of AV services (and associated fees) that the AV may perform before or after the AV's battery is charged if the AV is dispatched to a private service station or public service station for charging at a particular time, the power consumption and/or efficiency of the AV, the maintenance service needs of other AVs in the fleet that are located in the area or will be located in the area at a future time, the maintenance service demands at private and/or public service stations in the area, and/or any other factors.

The AV management system can provide various incentives to users for registering their private premises and allowing AVs to use their private premises for maintenance service needs of the AV. For example, when an AV uses the private premises registered by a user as a private service station to charge the battery of the AV, the AV management system can provide the user associated with the private premises a discount or reward to any service(s) provided by the AVs in a fleet, a credit to any service(s) provided by the AVs in the fleet, provide a free AV service to the user, offer the user extra or enhanced AV services or service features, given the user priority to AV services over other users, and/or provide any other benefits. For example, when an AV uses the private premises registered by a user as a private service station to charge the battery of the AV, the AV management system can reimburse the user the cost of the electricity used to charge the AV as well as an extra benefit such as an extra fee, a discount to an AV service, a credit to an AV service, an upgrade to an enhanced or premium service or service feature, a priority to an AV service over other users, and/or any other benefit.

In some cases, for convenience, an AV's use of a private premises registered by a user can also be scheduled around an AV service requested by the user. For example, if a user requests a ride from an AV to a destination, such as an airport, at a particular time in the future, the AV management system can offer to the user to send an AV prior to the scheduled time to charge the AV at the private premises so the AV is charged and ready in the private premises at the scheduled time. This way, the user does not have to worry about the AV arriving late (or not arriving) to the private premises for the requested ride, and can additionally receive a benefit from the AV management system such as a discount, credit, reward, etc.

As noted above, in some cases, a user can register private premises associated with the user for use by AVs in a fleet as a private battery charging station in a decentralized network of private stations. In some cases, a user can additionally or alternatively register the private premises for other maintenance service needs of AVs in the fleet. For example, the user can register the private premises as a location where AVs can go to be cleaned, have sensors calibrated/recalibrated, have tires checked, and/or receive any other type of AV maintenance service. The user can similarly provide a schedule of days and times that the user and the private premises would be available for use by AVs, and can receive notifications requesting confirmation when the AV management system intends to dispatch an AV to the private premises for maintenance service. The AV management system can provide the user any benefit for allowing an AV to use the private premises and the maintenance service provided by the user while the AV is at the private premises, such as a payment, a discount, a credit, an upgrade, a priority, etc.

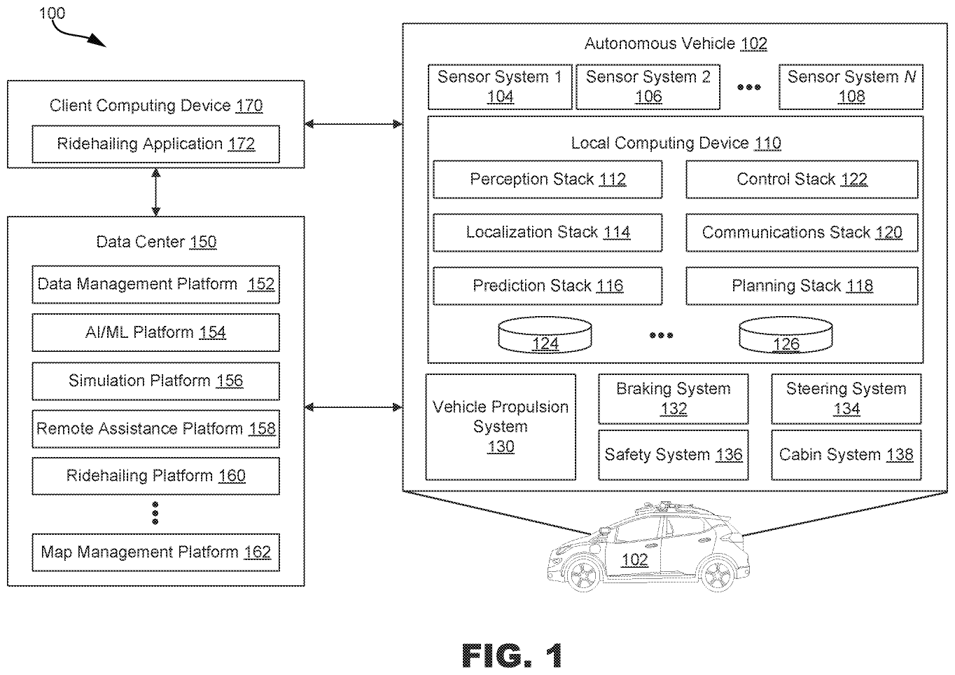

Examples of the systems and techniques described herein for processing data are illustrated in FIG. 1 through FIG. 7 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include one or more inertial measurement units (IMUs), camera sensors (e.g., still image camera sensors, video camera sensors, etc.), light sensors (e.g., LIDARs, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, time-of-flight (TOF) sensors, seat occupancy sensors, open/closed door sensors, tire pressure sensors, rain sensors, and so forth. For example, the sensor system 104 can include a camera system, the sensor system 106 can include a LIDAR system, and the sensor system 108 can include a RADAR system. Other examples may include any other number and type of sensors.

The AV 102 can include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

In some examples, the planning stack 118 can include multiple planning stacks and/or multiple planners (e.g., multiple planning stacks, multiple planning algorithms, multiple planning models, multiple planning nodes, multiple planning software and/or services, and/or multiple planning components) that the AV 102 can use to perform different maneuvers (and/or types of maneuvers), implement different parameters (e.g., different rules, different restrictions, different metrics, different standards, different states, and/or different behaviors), and/or navigate different scenes/environments (and/or types of scenes/environments), different conditions, different limitations, etc. For example, in some cases, the planning stack 118 can include a navigation planner and a specialized planner, as previously described. In some examples, the planning stack 118 can additionally or alternatively include other planners and/or a different number of planners. The local computing device 110 can intelligently and autonomously switch between different planners in/of the planning stack 118, as further described herein. For example, the local computing device 110 can autonomously switch between different planners in/of the planning stack 118 based on one or more factors such as, without limitation, a traffic rule, a restriction, a behavior, a scene, a state of the AV 102, a metric, a condition, a limitation, etc.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

Moreover, the local computing device 110 of the AV 102 can implement one or more AI/ML models to process data that the AI/ML models can use to make or generate various outputs, decisions, calculations, and/or predictions that the AV 102 can use to operate in an environment. For example, the perception stack, the localization stack 114, the prediction stack 116, the planning stack 188, the communications stack 120, the control stack 122, and/or any other software stack of the AV 102 can implement one or more AI/ML models used to process AV data.

The HD geospatial database 126 can store HD maps and related data of the streets upon which the AV 102 travels. In some examples, the HD maps and related data can include multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs (e.g., AV 102), Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the client application (e.g., ridehailing application 172) to enable passengers to view the AV 102 in transit to a pick-up or drop-off location, and so on.

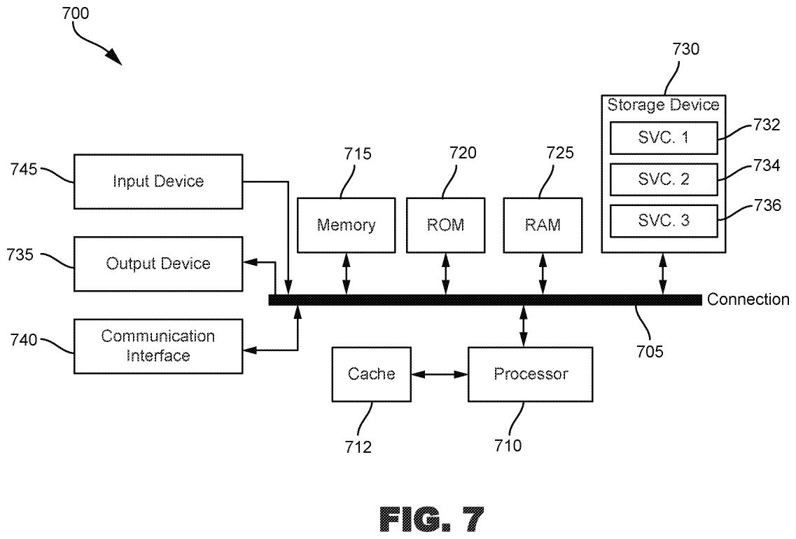

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can, in some instances, include one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

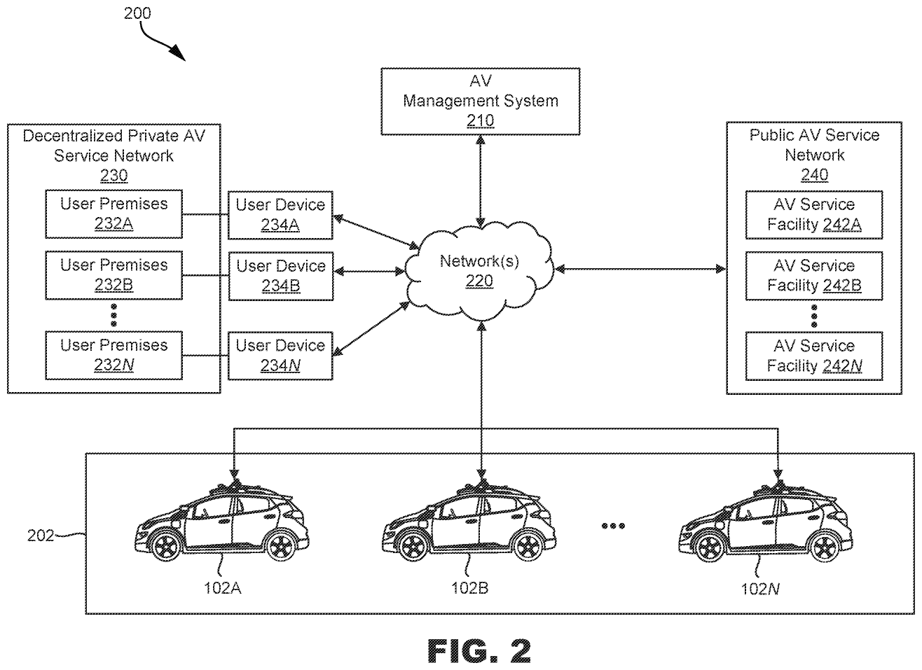

FIG. 2 is a diagram illustrating an example system environment 200 for a decentralized network of private service stations for AVs. The system environment 200 can include an AV fleet 202, an AV management system 210, a public AV service network 240, and a decentralized private AV service network 230 communicatively connected over a network(s) 220.

The network(s) 220 can include, for example and without limitation, a public network (e.g., the Internet, a public cloud network, etc.), a private network (e.g., a local area network, a private cloud, a virtual private network, etc.), a hybrid network (e.g., a public and private cloud network, a private and public network, etc.), a wireless network (e.g., a cellular network, a WI-FI network, etc.), and/or any other type of network(s). The AV fleet 202 can include AVs 102A-102N used to provide one or more AV services to users such as, for example and without limitation, product delivery services and/or ridesharing/ride-hailing services, among others.

The public AV service network 240 can include AV service facilities 242A-242N (collectively “AV service facilities 242” hereinafter) where the AVs 102A-102N can go as needed to charge their batteries. In some cases, the AV service facilities 242 can also provide other types of maintenance services to the AVs 102A-102N such as, for example and without limitation, sensor calibration, software and other upgrades, component installs/re-installs, component replacement, AV testing, repairs, routine maintenance, and/or any other type of AV maintenance services. The AV service facilities 242 can be located throughout one or more geographic areas such as, for example, one or more cities, one or more districts, one or more regions, one or more states, one or more countries, etc. For example, some or all of the AV service facilities 242 can be located at different areas/locations within a geographic area which enables the AVs 102A-102N to select which AV service facility to use at any given time. Moreover, the AV service facilities 242 can represent service station businesses that provide AV maintenance services to AVs, such as AVs 102A-102N in the fleet 202. For example, the AV service facilities 242 can include one or more AV service stations owned by an entity associated with the AV management system 210 and/or the fleet 202, one or more AV service stations operating as a business and/or commercial venue, and/or one or more AV service stations that provide AV maintenance services to the public.

The decentralized private AV service network 230 can include user premises 232A-232N (collectively “user premises 232” hereinafter) registered by users associated with the user premises 232 with the AV management system 210 as private AV service stations that the AVs 102A-102N can use to receive one or more AV maintenance services such as, for example and without limitation battery charging, AV cleaning, sensor calibration, software and other upgrades, component installs/re-installs, component replacement, AV testing, repairs, routine maintenance, and/or any other type of AV maintenance services. In some examples, the user premises 232 can include battery charging infrastructure that the AVs 102A-102N can use to charge their batteries. This way, the options and locations for battery charging available to the AVs 102A-102N can increase beyond those provided by the public AV service network 240. Moreover, in some examples, the user premises 232 can include private homes, garages, and/or other structures that users can register as private AV maintenance service stations for use or limited use by AVs in the fleet 202. For example, the user premises 232 can include private residences that have tools and/or infrastructure to provide certain AV maintenance services to AVs in the fleet 202 (e.g., as opposed to the AV service facilities 242 which are not private residences or garages).

To communicate with users associated with the user premises 232, the AV management system 210 (and the AVs 102A-102N) can communicate, via the network(s) 220, with user devices 234A-234N of the users associated with the user premises 232. For example, the AV management system 210 can communicate with the user device 234A of a user associated with the user premises 232A to receive information about the user premises 232A and/or the user associated with the user premises 232A, send information (e.g., requests, notifications, confirmations, etc.) to the user associated with the user premises 232A, and/or exchange any other information with the user associated with the user premises 232A. The AV management system 210 can communicate with the user device 234B of a user associated with the user premises 232B to receive information about the user premises 232B and/or the user associated with the user premises 232B, send information (e.g., requests, notifications, confirmations, etc.) to the user associated with the user premises 232B, and/or exchange any other information with the user associated with the user premises 232B. Similarly, the AV management system 210 can communicate with the user device 234N of a user associated with the user premises 232A to receive information about the user premises 232N and/or the user associated with the user premises 232N, send information (e.g., requests, notifications, confirmations, etc.) to the user associated with the user premises 232N, and/or exchange any other information with the user associated with the user premises 232N.

The user devices 234A-234N can include any computing device with networking capabilities. For example, the user devices 234A-234N can include, without limitation, a desktop computer, a laptop computer, a tablet computer, a mobile device (e.g., a mobile phone, a smart watch, etc.), or any other computing device.

The users associated with the user premises 232 can register the user premises 232 with the AV management system 210, which can schedule AV management services for the AVs 102A-102N with service stations from the decentralized private AV service network 230 (e.g., with user premises 232 used as private service stations) and the public AV service network 240 (e.g., with AV service facilities 242 used as public service stations) and dispatch the AVs 102A-102N to the selected service stations. When a user registers user premises with the AV management system 210, the user can specify one or more days and times when the battery charging infrastructure at the user premises (and/or any other AV maintenance service) would be available for use by the AVs 102A-102N and when the user (or any other user in the user premises that can assist in servicing the AVs 102A-102N) would be available to connect an AV to the battery charging infrastructure (and/or to receive any other AV maintenance service) at the user premises to charge the battery of the AVs 102-102N. In some cases, when registering user premises with the AV management system 210, the user can also specify what AV maintenance services would be available at the user premises. For example, the user can specify that the user premises include battery charging infrastructure and can thus be used by the AVs 102A-102N to charge their batteries. As another example, the user can specify that the user premises include certain tools and/or items that the user can use to provide other AV maintenance services such as cleaning AVs, calibrating sensors, performing routine AV maintenance services, etc.

When the AV management system 210 receives a request from a user (e.g., from a user device of a user) to register user premises associated with the user, the AV management system 210 can register the user premises to include the user premises as additional locations where the AVs 102A-102N can charge their batteries and/or receive any other AV maintenance services. When registering a user premises, the AV management system 210 can include information associated with the user premises such as, for example and without limitation, the location of the user premises, the type of AV maintenance services available to the AVs 102A-102N at the user premises, the availability schedule provided by the user for the user premises, information about the user (e.g., user account, identifying information, information confirming that the user is authorized to volunteer the user premises for use by the AVs 102A-102N, user preferences, information about any other user authorized to assist the AVs 102A-102N at the user premises when obtaining an AV maintenance service at the user premises, etc.), and/or any other information about the user, the user premises, etc.

As previously noted, the AV management system 210 can schedule and/or dispatch the AVs 102A-102N to use any of the user premises 232 for maintenance service needs of the AVs 102A-102N, such as battery charging, and thereby expand the amount of service stations available to AVs in an area. For example, when an AV needs to charge its battery, the AV management system 210 can determine whether to dispatch the AV to specific user premises in the decentralized private AV service network 230 to charge its battery, dispatch the AV to an AV service facility in the public AV service network 240, or wait to dispatch the AV to a user premises or an AV service facility at a later time.

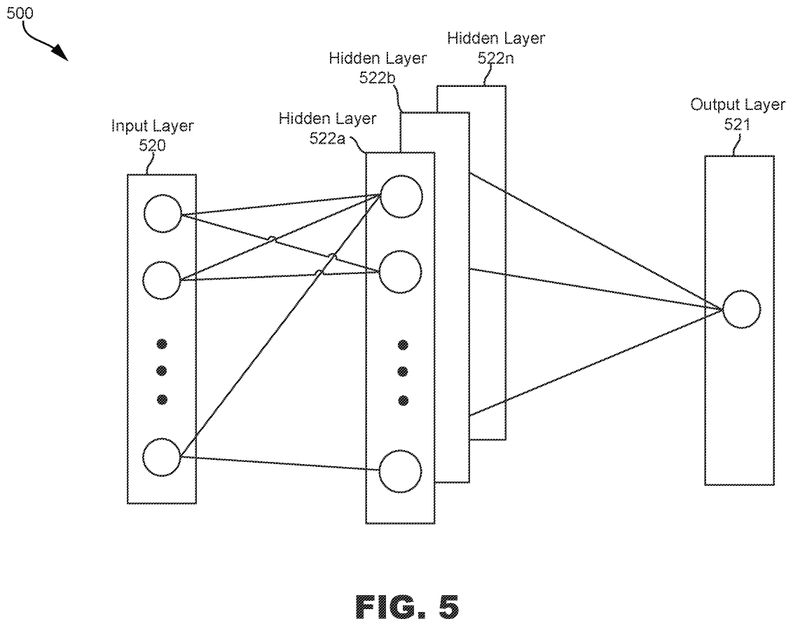

As further described herein, the AV management system 210 can coordinate the scheduling and use of the user premises 232 in the decentralized AV service network 230 and the AV service facilities 242 in the public AV service network 240, as well as the dispatching of the AVs 102A-102N to user premises 232 in the decentralized AV service network 230 and the AV service facilities 242 in the public AV service network 240. In some examples, the AV management system 210 can implement a machine learning model, such as the neural network 500 illustrated in FIG. 5, to coordinate the scheduling and use of the user premises 232 in the decentralized AV service network 230 and the AV service facilities 242 in the public AV service network 240.

Moreover, the AV management system 210 can do such coordination, scheduling, and dispatching based on a number of factors such as, for example and without limitation, the battery charge level of the AVs 102A-102N, the distance to one or more of the user premises 232 and the AV service facilities 242 from the locations of the AVs 102A-102N, the number of additional registered user premises located within a threshold proximity to a candidate user premises that are available as backup options in case an AV is dispatched to the candidate user premises and does not receive the requested AV service by a user at the candidate user premises, the amount of AV services (and associated fees) in the area(s) of an AV that the AV would forego if the AV is dispatched to specific user premises or an AV service facility at a particular time, the amount of AV services in the area of an AV (and associated fees) that the AV would forego if dispatching the AV to specific user premises or a specific AV service facility for AV maintenance service is delayed until a future time and the risk that a battery charge level of the AV may fall below a certain amount if charging of the AV's battery is delayed until the future time, an amount of AV services (and associated fees) that an AV may perform before or after the AV's battery is charged if the AV is dispatched to a specific user premises or specific AV service facility for charging at a particular time, the power consumption and/or efficiency of the AVs 102A-102N, the maintenance service needs of any of the AVs 102A-102N that are located in a given area or will be located in the given area at a future time, the maintenance service demands at any of the user premises 232 and/or the AV service facilities 242 in an area(s), and/or any other factors.

If the AV management system 210 intends to dispatch an AV to specific user premises in the decentralized private AV service network 230 for an AV maintenance service such as battery charging, the AV management system 210 can notify the user associated with the user premises and request confirmation that the user and any infrastructure (e.g., battery charging infrastructure), tools, and/or items will indeed be available for the AV to receive the specific AV maintenance service at the requested time (or time range) and/or when the AV is estimated to arrive at the user premises. For example, the AV management system 210 can send a notification to the user device (e.g., user device 234A, user device 234B, or user device 234N) of the user via the network(s) 220. If the user confirms such availability, the AV management system 210 can dispatch the AV to the user premises or confirm a dispatch instruction previously sent to the AV. Upon arrival of the AV at the user premises, the user can assist the AV by providing the AV maintenance service(s) for which the AV was dispatched to the user premises. For example, when the AV arrives at the user premises to charge its battery, the user can connect the AV to the battery charging infrastructure at the user premises to charge the battery of the AV, as the AV would need such assistance from a user.

If the user does not provide confirmation to the AV management system 210 (or does not provide confirmation within a threshold amount of time), the AV management system 210 can determine whether to dispatch the AV to another user premises in the area, dispatch the AV to a an AV service facility in the area from the public AV service network 240, or wait to dispatch the AV at a later time.

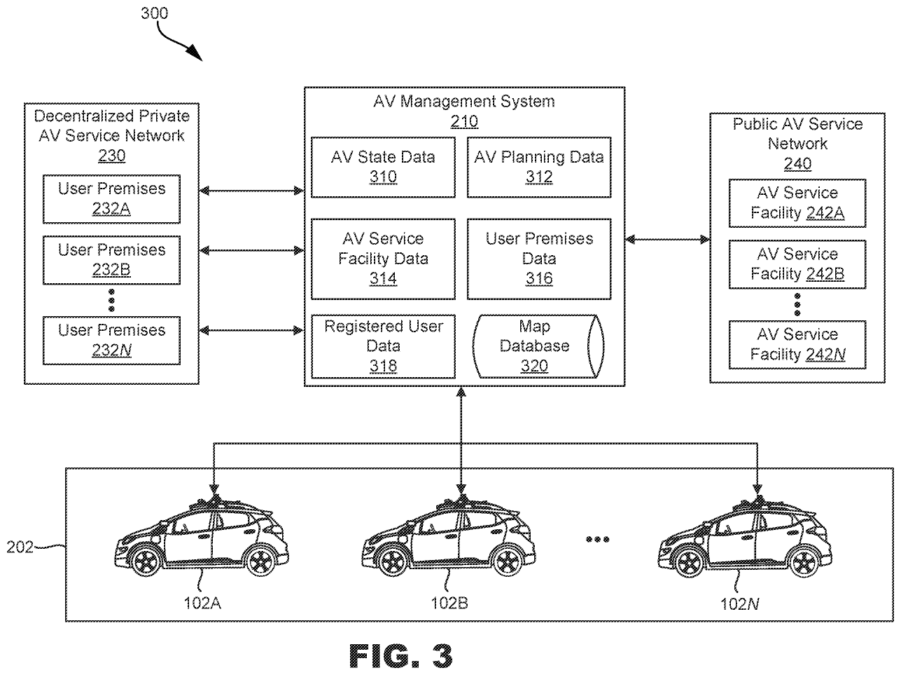

FIG. 3 is a diagram illustrating an example implementation 300 of the AV management system 210 in a system environment such as system environment 200 illustrated in FIG. 2. In this example, the AV management system 210 can collect and maintain AV state data 310, AV planning data 312, AV service facility data 314, user premises data 316, registered user data 318, and map data from a map database 320. The AV management system 210 (or a machine learning model of the AV management system 210 such as the neural network 500 illustrated in FIG. 5) can use such data to schedule AV maintenance services and dispatch the AVs 102A-102N to the user premises 232 in the decentralized AV service network 230 and AV service facilities 242 in the public AV service network 240. The AV management system 210 can use such data to coordinate use of the user premises 232 and the AV service facilities 242 by the AVs 102A-102N to receive AV maintenance services, such as battery charging, cleaning, sensor calibration, software upgrades, component installs/reinstalls, repairs, routine maintenance service, etc. For example, the AV management system 210 can use such data to schedule the AVs 102A-102N to charge their batteries at any of the user premises 232 and the AV service facilities 242, and dispatch the AVs 102A-102N to any of the user premises 232 and the AV service facilities 242 for battery charging.

In some examples, the AV state data 310 can include information about battery data (e.g., battery age, battery capacity, battery voltage, battery charge state or level, battery pack size, etc.) of each of the AVs 102A-102N. The AV state data 310 can also include any other information about the AVs 102A-102N an AV status, an AV maintenance state, a data storage capacity level, an amount of time until a power cycle is needed or due, an amount of time until sensor calibration is needed or due, a vehicle health-check cycle, error data, AV maintenance history information, AV statistics, sensor fault indications, AV log data, AV maintenance service status data, AV diagnostics data, AV trip state data, information about the type of AV, a passenger capacity of the AV, a software of the AV, AV capabilities information, AV maintenance services offered, AV restrictions and/or constraints, AV model information, tire pressure, energy efficiency, battery efficiency, driving range, maximum and/or minimum speed, maximal torque, engine temperature, and/or any other information about any of the AVs 102A-102N.

The AV planning data 312 can include any trip, routing, planning, usage, scheduling, dispatching, and/or service information about the AVs 102A-102N. For example, the AV planning data 312 can include any planned/scheduled (and/or potential) trips of any of the AVs 102A-102N, any planned routes (and/or potential routes) for any planned/scheduled trips of any of the AVs 102A-102N, any scheduled services and/or requests associated with any of the AVs 102A-102N, any received and/or pending trip and/or service requests that are unassigned to any of the AVs 102A-102N, the estimated times of arrival (ETAs) of any of the AVs 102A-102N to any destination locations associated with any trips, the distance and/or duration of any planned/scheduled and/or unscheduled trips, AV service and/or usage statistics associated with one or more service and/or usage times and/or timeframes, AV revenue statistics for any areas and/or associated AV service and/or usage times and/or timeframes, scheduling information associated with the AVs 102A-102N, dispatching information associated with any of the AVs 102A-102N, location information associated with any of the AVs 102A-102N (e.g., geographic coordinates, addresses, positions, orientations, poses, etc.), one or more operational design domains (ODDs) defining the driving areas/environments of the AVs 102A-102N, and/or AV schedules, among other information.

The AV service facility data 314 can include information about each of the AV service facilities 242 in the public AV service network 240. For example, the AV service facility data 314 can include the locations of each of the AV service facilities 242, the services offered by the AV service facilities 242, the scheduled maintenance services at the AV service facilities, the AV maintenance service capacity and/or capabilities of the AV service facilities 242, AV service availabilities at the AV service facilities 242, estimated or average maintenance service wait times at the AV service facilities 242, estimated or average maintenance service duration at the AV service facilities 242, AV maintenance service statistics at the AV service facilities 242, AV maintenance service peak and/or down times (e.g., times with over a threshold amount of AV maintenance service demands and/or times with less than a threshold amount of AV maintenance service demands) at the AV service facilities 242, number of AV agents/technicians (and/or available AV agents/technicians) at the AV service facilities 242, one or more AV maintenance service queues at the AV service facilities 242, and/or any other information about the AV service facilities 242.

The user premises data 316 can include information about the user premises 232 in the decentralized private AV service network 230. For example, the user premises data 316 can include the locations of the user premises 232, the availabilities and/or schedules specified for the user premises 232, information about the status of AV maintenance services scheduled and/or in progress at the user premises 232, information about AV maintenance services available/offered at the user premises 232, information about battery charging infrastructure at the user premises 232 (e.g., battery charging infrastructure available, battery charging infrastructure details, etc.), AV maintenance service statistics and/or histories of the user premises 232, descriptions of the user premises 232, numbers of AVs that can be serviced at the same time (or overlapping times) at the user premises 232, types of AV maintenance services that can be provided at the same time (or overlapping times) at the user premises 232, preferences associated with the user premises 232, attributes of the user premises 232, access information associated with the user premises 232 (e.g., entry and/or stop locations, routes to the user premises 232, traffic statistics associated with the user premises 232, parking information, etc.), and/or any other information about the user premises 232.

The registered user data 318 can include information about any users associated with the user premises 232. For example, the registered user data 318 can include schedules/availabilities of users to assist in providing AV maintenance services at the user premises 232, service preferences of the users, user account information (e.g., name, address, username, etc.), AV maintenance services previously rendered by the users, user ratings regarding AV maintenance services rendered by the users, trust information indicating reliabilities of the users to be available and/or provide an AV maintenance service at scheduled and/or committed times (e.g., based on whether the users where previously available when specified/scheduled, when confirmed by the users, and/or when an AV was dispatched to the user premises associated with such users), location information (e.g., locations of users made available by the users via their user devices and/or client applications used by the users), experience of the users providing AV maintenance services and/or assisting with AV maintenance services, which user premises is/are associated with the users, AV maintenance services received and/or requested by the users, AV maintenance service preferences of the users, benefits (e.g., credits, discounts, compensation, account and/or service upgrades, etc.) received and/or promised to the users for assistance with any AV maintenance services rendered and/or to be rendered, any AV services requested and/or scheduled by the users, and/or any other information about the users associated with the user premises 232.

The map database 320 can include maps used by the AVs 102A-102N to navigate one or more environments and/or any other map information such as mapping and/or localization information. For example, in some cases, the map database 320 can include routes, traffic information, tracked locations of the AVs 102A-102N, tracked positions of the AVs 102A-102N, tracked orientations of the AVs 102A-102N, parameters associated with routes (e.g., traffic lights, number of stop signs, speed limit(s), road grade information, elevation changes, school zones, intersections, construction zones, crosswalks, etc.), and/or any other map information. In some examples, the map database 320 can be the same as or correspond to the HD geospatial database 126 illustrated in FIG. 1.

As previously noted, the AV management system 210 can use the AV state data 310, AV planning data 312, AV service facility data 314, user premises data 316, registered user data 318, and map data from the map database 320 to schedule AV maintenance services at any of the user premises 232 in the decentralized AV service network 230 and/or the AV service facilities 242 in the public AV service network 240 and dispatch the AVs 102A-102N to the associated user premises 232 and/or AV service facilities 242. The AV management system 210 can use such data to coordinate use of the user premises 232 and/or the AV service facilities 242 by the AVs 102A-102N to receive AV maintenance services, such as battery charging, cleaning, sensor calibration, software upgrades, component installs/reinstalls, repairs, routine maintenance service, etc.

Moreover, the AV management system 210 can use such data to determine when to schedule an AV maintenance service for any of the AVs 102A-102N, where to schedule the AV maintenance service (e.g., a user premises from the user premises 232 or an AV service facility from the AV service facilities 242), and/or when to dispatch the AV(s) scheduled for an AV maintenance service to the scheduled user premises or AV service facility. The AV management system 210 can determine when and where (e.g., which user premises from the decentralized private AV service network 230 or AV service facility from the public AV service network 240) to schedule an AV maintenance service based on one or more factors, which can be determined at least in part from the AV state data 310, AV planning data 312, AV service facility data 314, user premises data 316, registered user data 318, and map data from the map database 320.

For example, AV management system 210 can determine when and where to schedule an AV maintenance service for an AV (e.g., AV 102A, AV 102B, and/or AV 102N) based on a balance and/or consideration of a number of risk and reward factors. Non limiting-examples of risk and reward factors can include the battery charge level of an AV, the battery capacity of the AV, the distance to any of the user premises 232 and/or the AV service facilities 242 from a location of the AV, the number of additional user premises and/or AV service facilities located within a threshold proximity (if any) to a candidate user premises that are available as backup options in case the AV is dispatched to the candidate user premises and does not receive charging assistance by a user at the candidate user premises, the amount of AV services in an area of the AV (and/or associated fees) that the AV would forego if the AV is dispatched to a particular user premises or AV service facility at a particular time (e.g., rather than waiting to dispatch the AV elsewhere and/or at a different time), the amount of AV services in an area of the AV (and/or associated fees) that the AV would forego if dispatching the AV to a particular user premises or AV service facility is delayed until a future time and the risk that a charge level of the AV may fall below a certain amount if charging of the AV's battery is delayed until the future time, an amount of services (and/or associated fees) that the AV may perform in an area(s) before or after the AV's battery is charged if the AV is dispatched to a particular user premises or AV service facility in the area(s) (or another area within a threshold proximity) for charging at a particular time, the power consumption and/or efficiency of the AV, the maintenance service needs of other AVs in the fleet 202 that are located in an area of the AV (or within a threshold proximity to the area) or will be located in the area at a future time, the maintenance service demands at any user premises and/or AV service facilities in the area, and/or any other factors.

To illustrate, assume that the AV state data 310 indicates that the battery charge level of AV 102A is at 20% and AV 102A is located within a certain distance to user premises 232A, which in this example has battery charging infrastructure as indicated by the user premises data 316, and a larger distance from AV service facility 242A, which in this example also has battery charging infrastructure as indicated by the AV service facility data 314, but the registered user data 318 indicates that the user associated with the user premises 232A has a trust level that is below a threshold (e.g., meaning that, from prior experiences, the user has had less than a threshold reliability in the sense that the user has not been available to assist an AV(s) dispatched to the user premises 232A after confirmation of the user's availability, which has caused the AV(s) to leave the user premises 232A to find another location to receive the AV maintenance service) and the AV service facility data 314 and user premises data 316 indicate that there are no user premises or AV service facilities with battery charging infrastructure within a threshold distance of the user premises 232A that the AV 102A can be dispatched to as backup if the AV 102 goes to the user premises 232A and the user does not charge the AV 102A. In this example, the AV management system 210 may determine to either risk dispatching the AV 102A to the user premises 232A despite the user trust level and lack of sufficient backup options or forego dispatching the AV 102A to the user premises 232A and instead dispatching the AV 102A to an AV service facility from the public AV service network 240 or a different user premises associated with a user with a higher trust level and/or located within a threshold proximity to one or more other user premises that the AV 102A can use as backup if the AV 102 is dispatched to the different user premises and the user associated with the different user premises does not assist in charging the AV 102A (e.g., which may prompt the AV management system 210 to dispatch the AV 102A elsewhere after having dispatched the AV 102A to the different user premises).

For example, if the AV management system 210 determines that the battery charge level of the AV 102A is sufficient for the AV 102A to reach the different user premises or AV service facility, the AV management system 210 may forego dispatching the AV 102A to the user premises 232A and instead dispatch the AV 102A to the different user premises or AV service facility. Alternatively, if the AV management system 210 determines that the battery charge level of the AV 102A is not sufficient for the AV 102A to reach the different user premises or AV service facility and/or the risk (e.g., in terms of cost and/or probability) of not dispatching the AV 102A to the user premises 232A and the battery of the AV 102A being drained (e.g., such that the AV 102A can no longer drive until the battery is recharged) is outweighed by the amount of fees that the AV 102A may be able to collect performing AV services (e.g., delivery and/or ridesharing/ride-hailing services) if the AV 102A is not dispatched to the user premises 232A, the AV management system 210 may decide to not dispatch the AV 102A to the user premises 232A and instead risk having the battery of the AV 102A becoming drained and/or attempting to dispatch the AV 102A elsewhere at a later time.

As another example, assume that the AV state data 310 indicates that the battery charge level of AV 102A is at 50% and AV 102A is located within a threshold distance to user premises 232A, which has battery charging infrastructure, and the user premises data 316 and/or AV service facility data 314 indicate that the user premises 232A is within a threshold distance(s) to a location(s) where an AV from the fleet 202 is requested to go for an AV service(s) (e.g., a product delivery service(s) and/or ridesharing-ride-hailing service(s)) at a scheduled time(s). If the AV management system 210 determines (e.g., based on the AV state data 310, AV planning data 312, AV service facility data 314, user premises data 316, registered user data 318, and map data from the map database 320) that the amount of fees/revenue collected by the AV 102A if the AV 102A is dispatched to the user premises 232A for charging prior to the scheduled time(s) and subsequently dispatched to perform the AV service(s) requested at the scheduled time(s) is greater than the amount of fees/revenue collected by the AV 102A (e.g., from any other AV services that the AV 102A can fulfill prior to the scheduled time(s)) if the AV 102A is not dispatched to the user premises 232A for charging until the battery charge level of the AV 102A is at a lower level (e.g., if battery charging is delayed to allow the AV 102A to fulfill any AV services requested within an area of the AV 102A), the AV management system 210 may decide to schedule the battery charging and dispatch the AV 102A to the user premises 232A prior to the scheduled time(s) to recharge the battery of the AV 102A prior to fulfilling the AV service(s) at the scheduled time(s) even though the battery charge level of the AV 102A is sufficient to allow the AV 102A to continue operating and schedule a battery recharge at a later time.

For example, the AV management system 210 may make such decision based on a determination that the AV 102A may obtain more fees/revenue if the AV 102A remains idle (e.g., not performing AV services) as it recharges its battery prior to the scheduled time(s) than the fees/revenue obtained by the AV 102A if the AV 102A instead foregoes recharging prior to the scheduled time(s) and continues performing any requested AV services (if any) until the battery recharge is scheduled at the later time. Alternatively, if the AV management system 210 determines that the AV 102A may obtain less fees/revenue if the AV 102A remains idle (e.g., not performing AV services) as it recharges its battery prior to the scheduled time(s) than the fees/revenue obtained by the AV 102A if the AV 102A instead foregoes recharging prior to the scheduled time(s) and continues performing any requested AV services until a battery recharge at the later time, the AV management system 210 may decide to not dispatch the AV 102A to the user premises 232A for charging prior to the scheduled time(s).

As yet another example, if a user associated with the user premises 232A requests a ride from an AV in the fleet 202 at a future time and the AV management system 210 determines that AV 102A has enough time to arrive at the user premises 232A and charge its battery there prior to the future time, the AV management system 210 may schedule the AV 102A to charge its battery at the user premises 232A and dispatch the AV 102A to the user premises 232A prior to the future time so the battery of the AV 102A can be charged prior to the future time (e.g., while the AV 102A waits until the future time to provide the ride to the user).

The AV management system 210 can provide users associated with the user premises 232 incentives for allowing AVs in the fleet 202 to use their user premises for AV maintenance services such as battery charging, cleaning, routine maintenance, sensor calibration, etc. For example, if AV 102A uses the user premises 232A to charge its battery, the AV management system 210 can provide a user associated with the user premises 232A an incentive for allowing the AV 102A to use the user premises 232A to charge its battery such as, for example and without limitation, a discount or reward, a credit to any service(s) provided by the AVs 102A-102N in the fleet 202, provide a free AV service to the user, offer the user extra or enhanced AV services or service features (e.g., unlock extra and/or enhanced services and/or service features), given the user priority to AV services over other users, and/or provide any other benefits. To illustrate, the AV management system 210 can provide the user a credit, discount, and/or compensation to reimburse the user for the cost of electricity used to charge the AV 102A and provide the user an additional benefit for allowing the AV 102A to use the user premises 232A to recharge and for the user's assistance in recharging the AV 102A.

In this way, by allowing users to register their user premises for use by the AVs 102A-102N in the fleet 202 to receive AV maintenance, the AV management system 210 can expand its network of locations available to provide AV maintenance to the AVs 102A-102N, while compensating such users for allowing their user premises to be used by the AVs 102A-102N and for assisting in providing AV maintenance to the AVs 102A-102N.

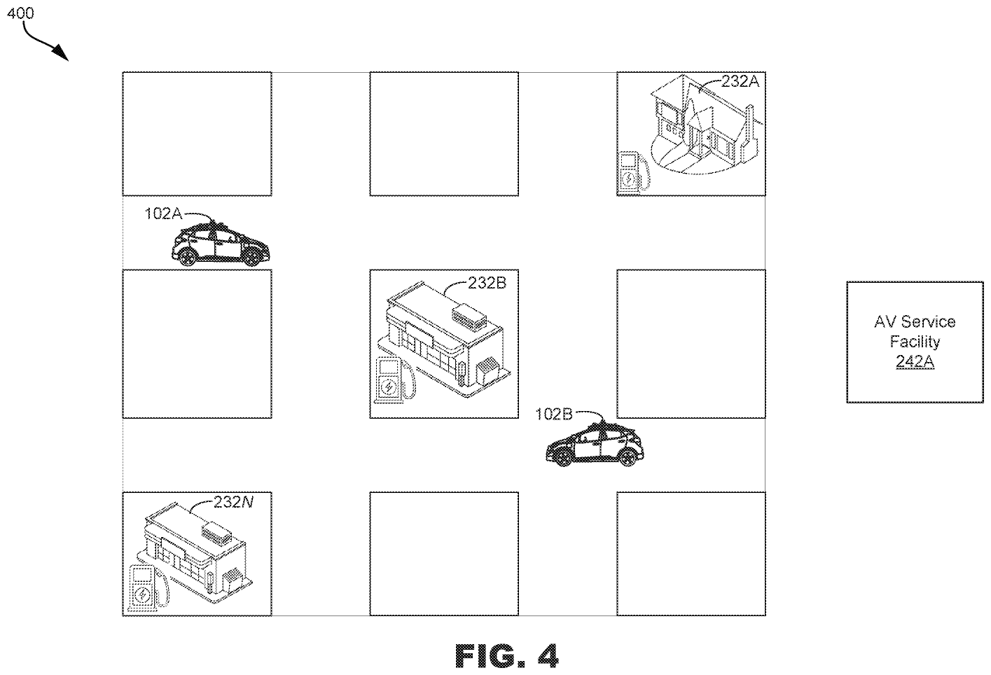

FIG. 4 is a diagram illustrating an example scene 400 where AVs (e.g., AVs 102A-102N) can be dispatched to user premises to receive AV maintenance services. In this example, the scene 400 includes user premises 232A, user premises 232B, and user premises 232N, and an AV service facility 242A is located outside of the scene 400 (e.g., within a proximity to the scene 400, in a different area than the scene 400, etc.). The scene 400 also includes AV 102A and AV 102B. The AVs 102A-102B can be in the scene 400 as they navigate routes taken by the AVs 102A-102B while performing a trip associated with an AV service (e.g., product delivery service, ridesharing/ride-hailing service, etc.), driving towards a pickup or destination location associated with an AV service, wait to be scheduled to perform an AV service, etc.

The AV management system 210 can determine whether AV 102A and/or AV 102B should be scheduled to use user premises 232A within the scene 400, user premises 232B within the scene 400, or AV service facility 242A outside of the scene 400 for any AV maintenance service. In some examples, to determine when and where to schedule AV 102A and AV 102B to receive an AV maintenance service, the AV management system 210 can weigh a number of factors.

For example, to determine whether AV 102A should be dispatched to user premises 232A, user premises 232B, user premises 232N, or AV service facility 242A to charge its battery, the AV management system 210 can determine the battery charge level of the AV 102A to determine the amount of time and/or distance that the AV 102 can continue to operate until the battery is drained or reaches a threshold level. The AV management system 210 can determine if the battery charge level of the AV 102A is enough for the AV 102A to be dispatched to and arrive at the AV service facility 242A before the battery is drained or reaches a threshold. If the battery charge level is enough for the AV 102A to be dispatched to and arrive at the AV service facility 242A, the AV management system 210 can determine a demand for AV services from the AV 102A in the scene 400 (and/or in one or more areas within a proximity to the scene 400 or within a proximity to the AV service facility 242A). In this example, if the demand for such AV services is below a threshold (and/or estimated to yield below a certain amount of fees/revenue), the AV management system 210 can determine whether to dispatch the AV 102A to the AV service facility 242A or any of the user premises 102A, 102B, or 102N. To illustrate, if the amount of fees/revenue from AV service demands in an area(s) of the AV service facility 242A (and/or within a proximity to the AV service facility 242A) exceeds (e.g., when accounting for any costs from driving to the AV service facility 242A) an amount of fees/revenue that would be obtained by the AV 102A if the AV 102A remains in the scene 400), the AV management system 210 may dispatch the AV 102A to the AV service facility 242A rather than dispatching the AV 102A to any of the user premises 232A, 232B, or 232N.

On the other hand, if the amount of fees/revenue from AV service demands in an area(s) of the AV service facility 242A (and/or within a proximity to the AV service facility 242A) does not exceed (e.g., when accounting for any costs from driving to the AV service facility 242A) an amount of fees/revenue that would be obtained by the AV 102A if the AV 102A remains in the scene 400), the AV management system 210 may forego dispatching the AV 102A to the AV service facility 242A. Instead, the AV management system 210 may determine whether to dispatch the AV 102A to one of the user premises 232A, 232B, or 232N or wait to dispatch the AV 102A at a later time. To determine whether to dispatch the AV 102A to one of the user premises 232A, 232B, or 232N or which of the user premises 232A, 232B, or 232N to dispatch the AV 102A, the AV management system 210 can consider one or more additional factors such as, for example, the AV maintenance service demands of the other AV in the scene 400 (e.g., AV 102B); the maintenance service infrastructure at the user premises 232A, 232B, and 232N; the trust levels of the users associated with the user premises 232A, 232B, and 232N; the number of user premises in the scene 400 that are available to provide the desired AV maintenance service to the AV 102A; and/or future AV service demands (e.g., schedule or predicted/estimated) in the scene 400 (and/or an area(s) within a proximity to the scene 400) and/or an area associated with the AV service facility 242A; among others.

For example, if the user associated with the user premises 232B has a threshold trust level (e.g., determined based on the number of times that the user has agreed to have an AV(s) dispatched to the user premises 232B (and/or other user premises associated with the user) and has or has not assisted the AV(s) when the AV(s) arrived at the user premises associated with the user), the AV management system 210 may select the user premises 232B for the AV 102A to charge its battery because of the trust level of the user and because the AV 102A is closer to the user premises 232B than the other user premises in the scene 400. If the user associated with the user premises 232B does not have a threshold trust level, the AV management system 210 may nevertheless select the user premises 232B for the AV 102A to charge its battery if the user premises 102A and/or the user premises 102N are also available for the AV 102A to charge its battery as backup if the AV 102A is dispatched to the user premises 232B and has to be subsequently dispatched elsewhere because the user associated with the user premises 232B does not assist the AV 102A with the battery charging when the AV 102A arrives at the user premises 232B (or within a threshold amount of time).

On the other hand, if the user associated with the user premises 232B does not have a threshold trust level and the user premises 102A and/or the user premises 102N are not available for the AV 102A to charge its battery as backup, the AV management system 210 may select the AV service facility 242A for the AV 102A to charge its battery. As another example, if the user associated with the user premises 232B does not have a threshold trust level and the user premises 102N are not available for the AV 102A to charge its battery as backup and the user premises 232A are available for use by the AV 102A as backup but there is also demand from the AV 102B for use of the user premises 232B, the AV management system 210 may select the AV service facility 242A for the AV 102A to charge its battery or may select the user premises 232B for use by the AV 102A and forego scheduling use of the user premises 232A by the AV 102B (or balance scheduling use of the user premises 232A by both the AV 102A and the AV 102B).

The AV management system 210 can similarly determine the AV maintenance service demands of the AV 102B to determine when and where to schedule the AV maintenance service for the AV 102B. For example, if the AV 102 is requested for an AV service to a user associated with the user premises 232A and the user premises 232A is available prior to the requested time for the AV service, the AV management system 210 can determine to dispatch the AV 102B to the user premises 232A prior to the requested time to charge its battery until the battery charge level is full or until the requested time.

In some cases, when determining when and where to schedule an AV maintenance service for the AV 102A and the AV 102B, the AV management system 210 can apply different weights to some or all of the factors considered by the AV management system 210. For example, the AV management system 210 may apply a first weight to the distance of a specific user premises, a second weight to a distance to an AV service facility (e.g., AV service facility 242A), a third weight to a trust level of a user associated with the specific user premises, a fourth weight to a battery charge level of the AV 102A (and/or any other AV maintenance service), a fifth weight to an amount of demand for AV services in the scene 400 at one or more times (e.g., before, during, and/or after the AV receives a desired AV maintenance service), a sixth weight to a cost of retrieving the AV if the AV is unable to continue driving because it did not receive an AV maintenance service in time (e.g., because the battery of the AV was drained before it was recharged), a seventh weight to a number of backup user premises and/or AV service facilities within region (e.g., in the scene 400, within a proximity to the scene 400, etc.), an eight weight to a number of AVs in the scene 400 (or within a proximity to the scene 400) that may need an AV maintenance service within the scene 400 or within a certain amount of time or distance, and/or any other weights for any other factors. Any of the weights of any factors can be different or the same. The AV management system 210 can apply the weights to the factors to determine when and where to schedule an AV maintenance service for an AV in the fleet 400, such as AV 102A and AV 102B in the scene 400.

As part of selecting a user premises for an AV to go to for an AV maintenance service, the AV management system 210 can check a schedule of availabilities of the user premises. In some cases, if the user premises is available at a desired time, the AV management system 210 can additionally send a confirmation request to a user associated with the user premises. If the user confirms that the user premises is available and the user will be available to assist the AV in obtaining the AV maintenance service within a threshold period of time, the AV management system 210 can dispatch the AV to the user premises. If the user does not confirm that the user premises is available and the user will be available to assist the AV in obtaining the AV maintenance service within a threshold period of time, the AV management system 210 can determine whether to dispatch the AV to a different location or delay the AV maintenance service for the AV to a later time.

In FIG. 5, the disclosure now turns to a further discussion of models that can be used by the AV management system 210 to coordinate use of user premises and AV service facilities by the fleet 202 to receive maintenance services.

FIG. 5 is a diagram illustrating an example of a neural network 500 that can be used to implement all or a portion of the systems and techniques described herein as discussed above (e.g., neural network 500 can be used to determine where and when to schedule and dispatch AVs to receive AV maintenance services). For example, an input layer 520 can be configured to receive the AV state data 310, AV planning data 312, AV service facility data 314, user premises data 316, registered user data 318, and map data from a map database 320. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n. For instance, the output may include a predicted charge state for an AV upon navigating to an AV maintenance facility and/or one or more waypoints associated with dispatch data. In another example, the output layer may include routing instructions for directing an AV fleet to attend to one or more service requests (e.g., based on dispatch data) and navigate to AV maintenance facilities for battery charging and AV maintenance.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 can be pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=>Σ(½ (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

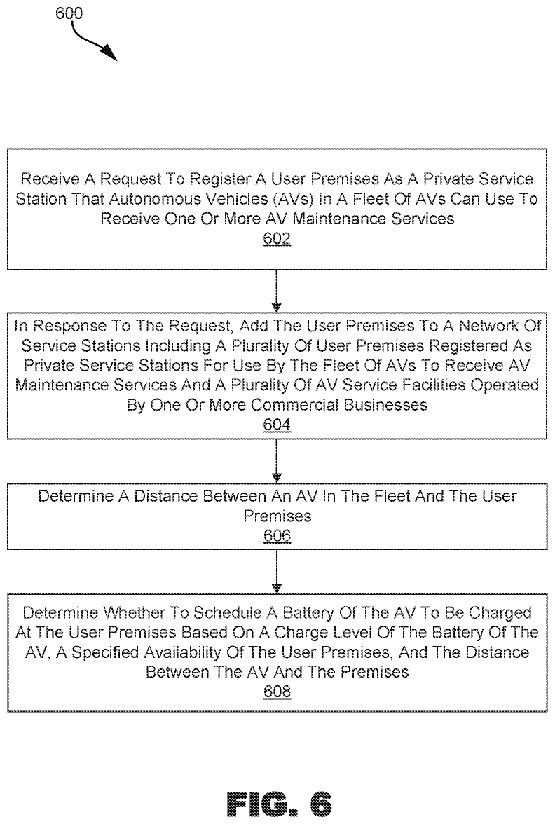

FIG. 6 is a flowchart illustrating an example process 600 for implementing a decentralized network of private service stations along with a network of AV service facilities. Although the example process 600 depicts a particular sequence of operations, the sequence may be altered without departing from the scope of the present disclosure. For example, some of the operations depicted may be performed in parallel or in a different sequence that does not materially affect the function of process 600. In other examples, different components of an example device or system that implements process 600 may perform functions at substantially the same time or in a specific sequence.

At block 602, the process 600 can include receiving a request to register a user premises (e.g., user premises 232A, user premises 232B, or user premises 232N) as a private service station that AVs in a fleet of AVs (e.g., fleet 202) can use to receive one or more AV maintenance services. The request can specify an availability of the user premises for use as the private service station to provide the one or more AV maintenance services. The one or more AV maintenance services can include, for example and without limitation, battery charging, tire maintenance, sensor calibration, vehicle cleaning, repairs, upgrades, routine maintenance, and/or any other maintenance service.

In some examples, the user premises can include a private residence with a vehicle charger. In some cases, the user premises can include a private residence or garage with tools and/or infrastructure that can be used to provide the one or more AV maintenance services.

At block 604, the process 600 can include in response to the request, adding the user premises to a network of service stations that includes a plurality of user premises (e.g., user premises 232) registered as private service stations for use by the one or more AVs to receive AV maintenance services and a plurality of AV service facilities (e.g., AV service facilities 242) operated by one or more commercial businesses.

At block 606, the process 600 can include determining a distance between an AV in the fleet and the user premises. For example, the AV management system 210 can determine a location of the AV and a location of the user premises, and determine the distance between the AV and the user premises based on the locations of the AV and the user premises.

At block 608, the process 600 can include determining whether to schedule a battery of the AV to be charged at the user premises based on a charge level of the battery of the AV, a specified availability of the user premises, and the distance between the AV and the premises.

In some aspects, the process 600 can include scheduling the battery of the AV to be charged at the user premises; sending, to a user device associated with a user associated with the user premises, a message requesting confirmation that the user and the user premises are available at a particular time; and determining whether to dispatch the AV to the user premises for charging of the battery of the AV based on whether the confirmation was received within a threshold period of time. For example, the AV management system can dispatch the AV to the user premises if the confirmation is received within the threshold period of time, or dispatch the AV to different user premises or an AV service facility (or delay dispatching the AV) if the confirmation is not received within the threshold period of time.

In some aspects, the process 600 can include determining whether a service station is within a threshold proximity to a first location of the AV and/or a second location of the user premises; and determining whether to schedule the battery of the AV to be charged at the user premises based on whether the service station is within the threshold proximity to the first location of the AV and/or the second location of the user premises. In some examples, the service station can include an AV service facility from the plurality of AV service facilities or an additional user premises from the plurality of user premises.

In some aspects, the process 600 can include determining whether a user associated with the user premises has been unavailable to assist any AVs in the fleet with a scheduled AV maintenance service at the user premises after confirming availability at a scheduled time; based on the determining whether the user has been unavailable to assist any AVs in the fleet with the scheduled AV maintenance service at the user premises after confirming availability at the scheduled time, determining a reliability of the user to perform a schedule AV maintenance service on one or more AVs dispatched to the user premises at a confirmed time; and determining whether to schedule the battery of the AV to be charged at the user premises further based on the reliability of the user.

In some cases, determining whether to schedule the battery of the AV to be charged at the user premises can include determining to schedule the battery of the AV to be charged at the user premises based on a determination that the reliability of the user is above a threshold and/or a determination that the service station is within the threshold proximity to the first location of the AV and/or the second location of the user premises.

In some cases, determining whether to schedule the battery of the AV to be charged at the user premises can include determining not to schedule the battery of the AV to be charged at the user premises based on a determination that the reliability of the user is below a threshold and/or a determination that the service station is not within the threshold proximity to the first location of the AV and/or the second location of the user premises; and based on the determining not to schedule the battery of the AV to be charged at the user premises, scheduling the battery of the AV to be charged at the service station, a different user premises, or a different AV service facility from the plurality of AV service facilities.

In some cases, determining whether to schedule the battery of the AV to be charged at the user premises can include determining a demand within a timeframe for AV services in a geographic area associated with a location of the AV and/or a location of the user premises; and based on the demand within the timeframe for AV services in the geographic area, determining whether to schedule the battery of the AV to be charged at the user premises and a time within the timeframe.

In some examples, determining whether to schedule the battery of the AV to be charged at the user premises and the time within the timeframe can include determining that demand within the timeframe for AV services in the geographic area is below a threshold; and based on the determining that the demand within the timeframe for AV services in the geographic area is below the threshold, determining to schedule the battery of the AV to be charged at the user premises and the time within the timeframe.

In some cases, determining whether to schedule the battery of the AV to be charged at the user premises and the time within the timeframe can include, based on a determination that the charge level of the battery is above the threshold and a determination that demand within the timeframe for AV services in the geographic area is above a demand threshold, determining not to schedule the battery of the AV to be charged at the user premises and the time within the timeframe.

In some examples, determining whether to schedule the battery of the AV to be charged at the user premises can include scheduling the battery of the AV to be charged at the user premises; dispatching the AV to the user premises; and based on a determination that the battery of the AV was at least partially charged at the user premises, providing compensation for use of the user premises to a user associated with the user premises. In some cases, the compensation can include a payment, a credit, a discount to an AV service(s), a user account upgrade, an upgrade to one or more AV services and/or service features, and/or any other benefit.

FIG. 7 illustrates an example processor-based system with which some aspects of the subject technology can be implemented. For example, processor-based system 700 can be any computing device such as local computing device 110, client computing device 170, and/or AV management system 210, in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communication interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some examples, a hardware service that performs a particular function can include the software component stored in a computer-readable medium in connection with the necessary hardware components, such as processor 710, connection 705, output device 735, etc., to carry out the function.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: memory and one or more processors coupled to the memory, the one or more processors configured to: receive a request to register a user premises as a private service station that autonomous vehicles (AVs) in a fleet of AVs can use to receive one or more AV maintenance services, the request specifying an availability of the user premises for use as the private service station to provide the one or more AV maintenance services; in response to the request, add the user premises to a network of service stations comprising a plurality of user premises registered as private service stations for use by the one or more AVs to receive AV maintenance services and a plurality of AV service facilities operated by one or more commercial businesses; determine a distance between an AV in the fleet and the user premises; and determine whether to schedule a battery of the AV to be charged at the user premises based on a charge level of the battery of the AV, the specified availability of the user premises, and the distance between the AV and the user premises.

Aspect 2. The system of Aspect 1, wherein the one or more processors are configured to: schedule the battery of the AV to be charged at the user premises; send, to a user device associated with a user associated with the user premises, a message requesting confirmation that the user and the user premises are available at a particular time; and determine whether to dispatch the AV to the user premises for charging of the battery of the AV based on whether the confirmation was received within a threshold period of time.

Aspect 3. The system of any of Aspects 1 to 2, wherein the one or more processors are configured to: determine whether a service station is within a threshold proximity to at least one of a first location of the AV and a second location of the user premises, the service station comprising an AV service facility from the plurality of AV service facilities or an additional user premises from the plurality of user premises; and determine whether to schedule the battery of the AV to be charged at the user premises based on whether the service station is within the threshold proximity to at least one of the first location of the AV and the second location of the user premises.

Aspect 4. The system of Aspect 3, wherein the one or more processors are configured to: determine whether a user associated with the user premises has been unavailable to assist any AVs in the fleet with a scheduled AV maintenance service at the user premises after confirming availability at a scheduled time; based on the determining whether the user has been unavailable to assist any AVs in the fleet with the scheduled AV maintenance service at the user premises after confirming availability at the scheduled time, determine a reliability of the user to perform a schedule AV maintenance service on one or more AVs dispatched to the user premises at a confirmed time; and determine whether to schedule the battery of the AV to be charged at the user premises further based on the reliability of the user.

Aspect 5. The system of Aspect 4, wherein determining whether to schedule the battery of the AV to be charged at the user premises comprises: determining to schedule the battery of the AV to be charged at the user premises based on at least one of a determination that the reliability of the user is above a threshold and a determination that the service station is within the threshold proximity to at least one of the first location of the AV and the second location of the user premises.

Aspect 6. The system of Aspect 4, wherein determining whether to schedule the battery of the AV to be charged at the user premises comprises: determining not to schedule the battery of the AV to be charged at the user premises based on at least one of a determination that the reliability of the user is below a threshold and a determination that the service station is not within the threshold proximity to at least one of the first location of the AV and the second location of the user premises; and based on the determining not to schedule the battery of the AV to be charged at the user premises, scheduling the battery of the AV to be charged at the service station, a different user premises, or a different AV service facility from the plurality of AV service facilities.

Aspect 7. The system of any of Aspects 1 to 6, wherein determining whether to schedule the battery of the AV to be charged at the user premises comprises: determining a demand within a timeframe for AV services in a geographic area associated with at least one of a location of the AV and a location of the user premises; and based on the demand within the timeframe for AV services in the geographic area, determining whether to schedule the battery of the AV to be charged at the user premises and a time within the timeframe.

Aspect 8. The system of Aspect 7, wherein determining whether to schedule the battery of the AV to be charged at the user premises and the time within the timeframe comprises: determining that demand within the timeframe for AV services in the geographic area is below a threshold; and based on the determining that the demand within the timeframe for AV services in the geographic area is below the threshold, determining to schedule the battery of the AV to be charged at the user premises and the time within the timeframe.

Aspect 9. The system of Aspect 7, wherein determining whether to schedule the battery of the AV to be charged at the user premises and the time within the timeframe comprises: based on a determination that the charge level of the battery is above the threshold and a determination that demand within the timeframe for AV services in the geographic area is above a demand threshold, determining not to schedule the battery of the AV to be charged at the user premises and the time within the timeframe.

Aspect 10. The system of any of Aspects 1 to 9, wherein the user premises comprises a private residence with a vehicle charger, and wherein determining whether to schedule the battery of the AV to be charged at the user premises comprises: scheduling the battery of the AV to be charged at the user premises; dispatching the AV to the user premises; and based on a determination that the battery of the AV was at least partially charged at the user premises, providing compensation for use of the user premises to a user associated with the user premises.

Aspect 11. A method comprising: receiving a request to register a user premises as a private service station that autonomous vehicles (AVs) in a fleet of AVs can use to receive one or more AV maintenance services, the request specifying an availability of the user premises for use as the private service station to provide the one or more AV maintenance services; in response to the request, adding the user premises to a network of service stations comprising a plurality of user premises registered as private service stations for use by the one or more AVs to receive AV maintenance services and a plurality of AV service facilities operated by one or more commercial businesses; determining a distance between an AV in the fleet and the user premises; and determining whether to schedule a battery of the AV to be charged at the user premises based on a charge level of the battery of the AV, the specified availability of the user premises, and the distance between the AV and the user premises.

Aspect 12. The method of Aspect 11, further comprising: scheduling the battery of the AV to be charged at the user premises; sending, to a user device associated with a user associated with the user premises, a message requesting confirmation that the user and the user premises are available at a particular time; and determining whether to dispatch the AV to the user premises for charging of the battery of the AV based on whether the confirmation was received within a threshold period of time.

Aspect 13. The method of any of Aspects 11 to 12, further comprising: determining whether a service station is within a threshold proximity to at least one of a first location of the AV and a second location of the user premises, the service station comprising an AV service facility from the plurality of AV service facilities or an additional user premises from the plurality of user premises; and determining whether to schedule the battery of the AV to be charged at the user premises based on whether the service station is within the threshold proximity to at least one of the first location of the AV and the second location of the user premises.

Aspect 14. The method of Aspect 13, further comprising: determining whether a user associated with the user premises has been unavailable to assist any AVs in the fleet with a scheduled AV maintenance service at the user premises after confirming availability at a scheduled time; based on the determining whether the user has been unavailable to assist any AVs in the fleet with the scheduled AV maintenance service at the user premises after confirming availability at the scheduled time, determining a reliability of the user to perform a schedule AV maintenance service on one or more AVs dispatched to the user premises at a confirmed time; and determining whether to schedule the battery of the AV to be charged at the user premises further based on the reliability of the user.

Aspect 15. The method of Aspect 14, wherein determining whether to schedule the battery of the AV to be charged at the user premises comprises: determining to schedule the battery of the AV to be charged at the user premises based on at least one of a determination that the reliability of the user is above a threshold and a determination that the service station is within the threshold proximity to at least one of the first location of the AV and the second location of the user premises.

Aspect 16. The method of Aspect 14, wherein determining whether to schedule the battery of the AV to be charged at the user premises comprises: determining not to schedule the battery of the AV to be charged at the user premises based on at least one of a determination that the reliability of the user is below a threshold and a determination that the service station is not within the threshold proximity to at least one of the first location of the AV and the second location of the user premises; and based on the determining not to schedule the battery of the AV to be charged at the user premises, scheduling the battery of the AV to be charged at the service station, a different user premises, or a different AV service facility from the plurality of AV service facilities.

Aspect 17. The method of any of Aspects 11 to 16, wherein determining whether to schedule the battery of the AV to be charged at the user premises comprises: determining a demand within a timeframe for AV services in a geographic area associated with at least one of a location of the AV and a location of the user premises; and based on the demand within the timeframe for AV services in the geographic area, determining whether to schedule the battery of the AV to be charged at the user premises and a time within the timeframe.

Aspect 18. The method of Aspect 17, wherein determining whether to schedule the battery of the AV to be charged at the user premises and the time within the timeframe comprises: determining that demand within the timeframe for AV services in the geographic area is below a threshold; and based on the determining that the demand within the timeframe for AV services in the geographic area is below the threshold, determining to schedule the battery of the AV to be charged at the user premises and the time within the timeframe.

Aspect 19. The method of Aspect 17, wherein determining whether to schedule the battery of the AV to be charged at the user premises and the time within the timeframe comprises: based on a determination that the charge level of the battery is above the threshold and a determination that demand within the timeframe for AV services in the geographic area is above a demand threshold, determining not to schedule the battery of the AV to be charged at the user premises and the time within the timeframe.

Aspect 20. The method of any of Aspects 11 to 19, wherein the user premises comprises a private residence with a vehicle charger, and wherein determining whether to schedule the battery of the AV to be charged at the user premises comprises: scheduling the battery of the AV to be charged at the user premises; dispatching the AV to the user premises; and based on a determination that the battery of the AV was at least partially charged at the user premises, providing compensation for use of the user premises to a user associated with the user premises.

Aspect 21. A non-transitory computer-readable medium having stored thereon instructions which, when executed by one or more processors, cause the one or more processors to perform a method according to any of Aspects 11 to 20.

Aspect 22. A system comprising means for performing a method according to any of Aspects 11 to 20.

Aspect 23. A computer-program product comprising instructions which, when executed by one or more processors, cause the one or more processors to perform a method according to any of Aspects 11 to 20.

What is claimed is:

1. A system comprising:
a memory; and
one or more processors coupled to the memory, the one or more processors configured to:
receive a request to register a user premises as a private service station that autonomous vehicles (AVs) in a fleet of AVs can use to receive one or more AV maintenance services, the request specifying an availability of the user premises for use as the private service station to provide the one or more AV maintenance services;
in response to the request, add the user premises to a network of service stations comprising a plurality of user premises registered as private service stations for use by the one or more AVs to receive AV maintenance services and a plurality of AV service facilities operated by one or more commercial businesses;
determine a distance between an AV in the fleet and the user premises; and
determine whether to schedule a battery of the AV to be charged at the user premises based on a charge level of the battery of the AV, the specified availability of the user premises, and the distance between the AV and the user premises.

2. The system of claim 1, wherein the one or more processors are configured to:
schedule the battery of the AV to be charged at the user premises;
send, to a user device associated with a user associated with the user premises, a message requesting confirmation that the user and the user premises are available at a particular time; and
determine whether to dispatch the AV to the user premises for charging of the battery of the AV based on whether the confirmation was received within a threshold period of time.

3. The system of claim 1, wherein the one or more processors are configured to:
determine whether a service station is within a threshold proximity to at least one of a first location of the AV and a second location of the user premises, the service station comprising an AV service facility from the plurality of AV service facilities or an additional user premises from the plurality of user premises; and
determine whether to schedule the battery of the AV to be charged at the user premises based on whether the service station is within the threshold proximity to at least one of the first location of the AV and the second location of the user premises.

4. The system of claim 3, wherein the one or more processors are configured to:
determine whether a user associated with the user premises has been unavailable to assist any AVs in the fleet with a scheduled AV maintenance service at the user premises after confirming availability at a scheduled time;
based on the determining whether the user has been unavailable to assist any AVs in the fleet with the scheduled AV maintenance service at the user premises after confirming availability at the scheduled time, determine a reliability of the user to perform a schedule AV maintenance service on one or more AVs dispatched to the user premises at a confirmed time; and
determine whether to schedule the battery of the AV to be charged at the user premises further based on the reliability of the user.

5. The system of claim 4, wherein determining whether to schedule the battery of the AV to be charged at the user premises comprises:
determining to schedule the battery of the AV to be charged at the user premises based on at least one of a determination that the reliability of the user is above a threshold and a determination that the service station is within the threshold proximity to at least one of the first location of the AV and the second location of the user premises.

6. The system of claim 4, wherein determining whether to schedule the battery of the AV to be charged at the user premises comprises:
determining not to schedule the battery of the AV to be charged at the user premises based on at least one of a determination that the reliability of the user is below a threshold and a determination that the service station is not within the threshold proximity to at least one of the first location of the AV and the second location of the user premises; and
based on the determining not to schedule the battery of the AV to be charged at the user premises, scheduling the battery of the AV to be charged at the service station, a different user premises, or a different AV service facility from the plurality of AV service facilities.

7. The system of claim 1, wherein determining whether to schedule the battery of the AV to be charged at the user premises comprises:
determining a demand within a timeframe for AV services in a geographic area associated with at least one of a location of the AV and a location of the user premises; and
based on the demand within the timeframe for AV services in the geographic area, determining whether to schedule the battery of the AV to be charged at the user premises and a time within the timeframe.

8. The system of claim 7, wherein determining whether to schedule the battery of the AV to be charged at the user premises and the time within the timeframe comprises:
determining that demand within the timeframe for AV services in the geographic area is below a threshold; and
based on the determining that the demand within the timeframe for AV services in the geographic area is below the threshold, determining to schedule the battery of the AV to be charged at the user premises and the time within the timeframe.

9. The system of claim 7, wherein determining whether to schedule the battery of the AV to be charged at the user premises and the time within the timeframe comprises:
based on a determination that the charge level of the battery is above the threshold and a determination that demand within the timeframe for AV services in the geographic area is above a demand threshold, determining not to schedule the battery of the AV to be charged at the user premises and the time within the timeframe.

10. The system of claim 1, wherein the user premises comprises a private residence with a vehicle charger, and wherein determining whether to schedule the battery of the AV to be charged at the user premises comprises:
scheduling the battery of the AV to be charged at the user premises;
dispatching the AV to the user premises; and
based on a determination that the battery of the AV was at least partially charged at the user premises, providing compensation for use of the user premises to a user associated with the user premises.

11. A method comprising:
receiving a request to register a user premises as a private service station that autonomous vehicles (AVs) in a fleet of AVs can use to receive one or more AV maintenance services, the request specifying an availability of the user premises for use as the private service station to provide the one or more AV maintenance services;
in response to the request, adding the user premises to a network of service stations comprising a plurality of user premises registered as private service stations for use by the one or more AVs to receive AV maintenance services and a plurality of AV service facilities operated by one or more commercial businesses;
determining a distance between an AV in the fleet and the user premises; and
determining whether to schedule a battery of the AV to be charged at the user premises based on a charge level of the battery of the AV, the specified availability of the user premises, and the distance between the AV and the user premises.

12. The method of claim 11, further comprising:
scheduling the battery of the AV to be charged at the user premises;
sending, to a user device associated with a user associated with the user premises, a message requesting confirmation that the user and the user premises are available at a particular time; and
determining whether to dispatch the AV to the user premises for charging of the battery of the AV based on whether the confirmation was received within a threshold period of time.

13. The method of claim 11, further comprising:
determining whether a service station is within a threshold proximity to at least one of a first location of the AV and a second location of the user premises, the service station comprising an AV service facility from the plurality of AV service facilities or an additional user premises from the plurality of user premises; and
determining whether to schedule the battery of the AV to be charged at the user premises based on whether the service station is within the threshold proximity to at least one of the first location of the AV and the second location of the user premises.

14. The method of claim 13, further comprising:
determining whether a user associated with the user premises has been unavailable to assist any AVs in the fleet with a scheduled AV maintenance service at the user premises after confirming availability at a scheduled time;
based on the determining whether the user has been unavailable to assist any AVs in the fleet with the scheduled AV maintenance service at the user premises after confirming availability at the scheduled time, determining a reliability of the user to perform a schedule AV maintenance service on one or more AVs dispatched to the user premises at a confirmed time; and
determining whether to schedule the battery of the AV to be charged at the user premises further based on the reliability of the user.

15. The method of claim 14, wherein determining whether to schedule the battery of the AV to be charged at the user premises comprises:
determining to schedule the battery of the AV to be charged at the user premises based on at least one of a determination that the reliability of the user is above a threshold and a determination that the service station is within the threshold proximity to at least one of the first location of the AV and the second location of the user premises.

16. The method of claim 14, wherein determining whether to schedule the battery of the AV to be charged at the user premises comprises:
determining not to schedule the battery of the AV to be charged at the user premises based on at least one of a determination that the reliability of the user is below a threshold and a determination that the service station is not within the threshold proximity to at least one of the first location of the AV and the second location of the user premises; and
based on the determining not to schedule the battery of the AV to be charged at the user premises, scheduling the battery of the AV to be charged at the service station, a different user premises, or a different AV service facility from the plurality of AV service facilities.

17. The method of claim 11, wherein determining whether to schedule the battery of the AV to be charged at the user premises comprises:
determining a demand within a timeframe for AV services in a geographic area associated with at least one of a location of the AV and a location of the user premises; and
based on the demand within the timeframe for AV services in the geographic area, determining whether to schedule the battery of the AV to be charged at the user premises and a time within the timeframe.

18. The method of claim 17, wherein determining whether to schedule the battery of the AV to be charged at the user premises and the time within the timeframe comprises:
determining that demand within the timeframe for AV services in the geographic area is below a threshold; and
based on the determining that the demand within the timeframe for AV services in the geographic area is below the threshold, determining to schedule the battery of the AV to be charged at the user premises and the time within the timeframe.

19. The method of claim 17, wherein determining whether to schedule the battery of the AV to be charged at the user premises and the time within the timeframe comprises:
based on a determination that the charge level of the battery is above the threshold and a determination that demand within the timeframe for AV services in the geographic area is above a demand threshold, determining not to schedule the battery of the AV to be charged at the user premises and the time within the timeframe.

20. A non-transitory computer-readable medium having stored thereon instructions which, when executed by one or more processors, cause the one or more processors to:
receive a request to register a user premises as a private service station that autonomous vehicles (AVs) in a fleet of AVs can use to receive one or more AV maintenance services, the request specifying an availability of the user premises for use as the private service station to provide the one or more AV maintenance services;
in response to the request, add the user premises to a network of service stations comprising a plurality of user premises registered as private service stations for use by the one or more AVs to receive AV maintenance services and a plurality of AV service facilities operated by one or more commercial businesses;
determine a distance between an AV in the fleet and the user premises; and
determine whether to schedule a battery of the AV to be charged at the user premises based on a charge level of the battery of the AV, the specified availability of the user premises, and the distance between the AV and the user premises.
